(19) United States
(12) Patent Application Publication
(10) Pub. No.: US 2025/0320887 A1
(43) Pub. Date: Oct. 16, 2025

(54) FAN SHROUD FOR A MOTOR VEHICLE

(71) Applicant: Brose Fahrzeugteile SE & Co. Kommanditgesellschaft, Wuerzburg, Wuerzburg (DE)

(72) Inventors: Amit BEDARE, Pune (IN); Andre EVERS, Oldenburg (DE); Anand PATEL, Oldenburg (DE); Shubhangi ASODE, Pune (IN); Nikhil MANKAR, Pune (IN)

(73) Assignee: Brose Fahrzeugteile SE & Co. Kommanditgesellschaft, Wuerzburg, Wuerzburg (DE)

(21) Appl. No.: 19/175,748

(22) Filed: Apr. 10, 2025

(30) Foreign Application Priority Data
Apr. 10, 2024 (DE) 10 2024 203 279.4

(51) Int. Cl. F16B 9/02; B60K 11/04; B60K 11/08

(52) U.S. Cl. CPC F16B 9/02; B60K 11/08; B60K 11/04

(57) ABSTRACT

The invention relates to a fan shroud for a motor vehicle, with a base body and with a holder for attaching a cooling hose. The holder is molded to the base body and has two spring tongues for at least partial gripping of the cooling hose. Furthermore, the invention relates to a radiator module for a motor vehicle.

This nonprovisional application claims priority under 35 U.S.C. § 119 (a) to German Patent Application No. 10 2024 203 279.4, which was filed in Germany on Apr. 10, 2024, and which is herein incorporated by reference.

### BACKGROUND OF THE INVENTION

### Field of the Invention

The invention relates to a fan shroud for a motor vehicle. The fan shroud has a base body and a holder for attaching a cooling hose. The invention also relates to a radiator module for a motor vehicle.

### Description of the Background Art

Motor vehicles with an internal combustion engine generate considerable heat during operation. To maintain the operating temperature of the combustion engine, a cooling circuit with a coolant is used, which in turn must be cooled. If the motor vehicle has an electric motor for propulsion, a high-voltage energy storage system is charged and discharged during operation, wherein heat loss also occurs here, so that the high-voltage energy storage system must be cooled. To maintain the operating temperature, a coolant is used, which in turn must be cooled. Alternatively, a refrigerant from a refrigeration circuit is used, especially if the high-voltage energy storage system is to be cooled. A corresponding refrigeration circuit is also used for the temperature control of an interior. When the refrigeration circuit is in operation, the refrigerant used must be cooled down.

To cool down the coolant/refrigerant, a radiator pressurized by a headwind is usually used. This has a radiator network, with several pipes through which the coolant/refrigerant is routed, and which are thermally contacted with fins or the like, which are exposed to a headwind. Thus, the excess heat of the coolant/refrigerant is transferred to the headwind via the pipes and the fins.

To conduct the coolant/refrigerant to the radiator network, cooling hoses are usually used, which are made of a comparatively flexible material, such as rubber or elastomer. Thus, even if the radiator network vibrates, there is no damage to the cooling hoses or detachment from the remaining components of the refrigeration circuit/cooling circuit.

To ensure that sufficient air passes through the radiator network when the vehicle is at a standstill, a fan is usually used. This has a fan wheel driven by an electric motor, for example, by means of which an air flow is created. To ensure that the air flow passes through the radiator network in a targeted manner, a fan shroud is usually used. By means of this, the radiator network is covered, with one or more openings so that the air can pass through. In one of these openings, the fan wheel of the fan is also located.

For simplified installation, the cooling hoses are usually attached to the fan shroud. This stabilizes them and avoids an undesirable change in position, which could negatively impact the operation of the fan, for example. Cable ties, metallic clips or screws are usually used for fastening, which are attached to the corresponding mounts of the fan shroud, for example after they have been attached to the radiator hose. In most cases, the mounts are slidably mounted on a base body of the fan shroud. This makes fastening easier, wherein after the clips/screws have been attached to the respective mount, they are pushed to a suitable position so that the cooling hose is stabilized on the fan shroud.

### SUMMARY OF THE INVENTION

It is therefore an object of the invention to provide a particularly suitable fan shroud for a motor vehicle and a particularly suitable radiator module for a motor vehicle, wherein installation is expediently simplified and/or manufacturing costs are reduced.

In an example, the fan shroud is suitable, in particular provided and set up, to be mounted on a motor vehicle. When installed, the fan shroud is mounted on a radiator network of the motor vehicle, for example. The motor vehicle is suitably land-bound and preferably multi-lane. In this case, it is suitably possible to position the motor vehicle essentially freely, especially on a roadway. For this purpose, the motor vehicle expediently has appropriate wheels. In summary, it is preferably possible to position the motor vehicle essentially independently of other conditions on land. In other words, the motor vehicle is suitably not rail-guided. Preferably, the motor vehicle is a passenger car or a commercial vehicle, such as a truck or bus.

The fan shroud can have a base body. This is particularly flat and suitably has a recess. The recess is conveniently round and preferably suitable, in particular provided and set up, for holding a fan wheel of a fan. For example, the base body includes further openings, which are closed in particular by means of swiveling/adjustable flaps that are conveniently attached to the base body. In particular, the flaps are designed in the style of a ram pressure flap, so that they open independently from a certain dynamic pressure acting on them.

The fan shroud also can have a holder for attaching a cooling hose. The holder is suitable for this purpose, in particular set up and provided. In other words, the cooling hose is attached to the fan shroud by means of the holder when assembled, especially to the base body. This prevents the cooling hose from detaching or otherwise changing its position with regard to the base body. The cooling hose is made of rubber or elastomer, for example. Appropriately, a cooling liquid is passed through the cooling hose during operation, such as a coolant or refrigerant. In particular, the cooling liquid is led to the possible radiator network, which is covered by the fan shroud. Conveniently, the cooling hose is connected to the radiator network using fluid technology.

The holder can be molded to the base body. This means that the holder can be attached to the base body in a way that prevents it from being lost and is materially connected to it. Conveniently, the holder is one-piece with the base body, and the fan shroud, or at least the base body and the holder, are made of the same material, preferably in the same step. Conveniently, the base body and the holder are created using a plastic injection molding process. A polyamide is preferably used as a plastic, especially a glass fiber reinforced polyamide, preferably PA6.

The holder can have two spring tongues, which are also suitably one-piece with the base body. The spring tongues are at least partially designed to bend resiliently and serve to grip the cooling hose at least partially. The spring tongues are suitable for this purpose, in particular provided and set up. When mounted, the spring tongues conveniently adjoin the cooling hose, for example by forming a clearance fit or preferably by force-fit.

In the case of the fan shroud, the holder can thus be securely attached to the base body, avoiding undesirable detachment of the holder from the base body during assembly or during operation, simplifying installation, and increasing robustness. There is also no assembly step of attaching the holder to the base body, which simplifies production. Conveniently, the fan shroud is made entirely from the material of the base body, from which the holder is also made. As a result, no different materials are required to manufacture the fan shroud, which means that storage is reduced. For example, contact corrosion or the like is also avoided.

Due to the spring tongues, the cooling hose can be mounted by means of elastic deformation, without the need for additional tools. This also makes assembly easier. In addition, disassembly is possible, especially by bending the spring tongues accordingly and removing the cooling hose. This also improves the serviceability/repair of the motor vehicle. In summary, on the one hand, there is no need to attach the holder to the base body during assembly, and the cooling hose can be mounted on the fan shroud without any additional tools. When assembled, due to the spring tongues gripping the cooling hose, it is comparatively securely connected to the fan shroud, so that unwanted detachment is avoided. It is also possible to use an existing tool, in particular an injection mold, which is merely suitably adapted by means of an appropriate slider in such a way that the holder is created in a single step with the base body.

Preferably, one of the spring tongues, preferably both spring tongues, can have an arc-shaped section that serves for the attachment to the radiator hose. In particular, in the mounted state, the cooling hose is gripped by means of the arc-shaped section, which is also merely referred to as the section in the following, and the cooling hose rests on the inside of the section. The sections are curved in opposite directions to each other with respect to a common axis. Thus, the same axis is assigned to the sections of the two spring tongues, and the center of the arc formed by means of the respective section is conveniently on the axis. Conveniently, the insides of the two sections are the same distance from the axis. In other words, the radius of the two sections is the same. For example, the sections are arranged in a common plane perpendicular to the axis and are therefore not offset from each other along the axis. However, they are particularly preferably offset from each other along the axis. Thus, construction is simplified. The course of the cooling hose is expediently along the axis, and the hose is appropriately arranged concentrically to the axis, at least in the area where it is gripped by means of the holder. Thus, the cooling hose is comparatively safely gripped by means of the two sections. Preferably, however, the two sections are offset from each other along the axis. Thus, for example, unintentional snagging of the section of the two spring tongues with each other is prevented, which makes insertion of the cooling hose and thus assembly easier. This also makes it easier to manufacture, especially if the fan shroud is designed as a plastic injection molded part.

For example, in the assembled state, the axis can be completely surrounded by the two sections on the circumferential side. Thus, even in the assembled state, the cooling hose is fully surrounded by the two sections. In this way, robustness is increased and unwanted detachment is safely avoided. However, particularly preferably, the axis is only partially surrounded by the two sections. Preferably, the axis is surrounded by means of the two sections by between 60% and 70% of the circumference. Thus, a gap/opening is formed between the ends of the sections pointed toward each other, in particular of the two spring tongues, through which the cooling hose can be inserted between the sections perpendicular to the course of the axis. As a result, for example, there is no need to thread the cooling hose along the axis between the two sections, which makes installation easier. Also, only a slight movement is required to enlarge the opening so that the cooling hose can be mounted comparatively easily. This reduces the force to be applied, and the comparatively small amount of movement required prevents the spring tongues from breaking unintentionally. This simplifies assembly and reduces rejects.

For example, each section can be attached directly to the base body at the end, i.e., especially at a first end. Thus, a comparatively compact fan shroud is provided. For example, this involves at least partial additional stabilization of the section on other components of the base body, i.e., in particular in an area separated from the first end. This increases robustness. Particularly preferably, however, a fastening section is formed at the first end pointing away from the axis, which is attached to a base body. In other words, the section is attached to the base body by means of the fastening section. For example, the section is also connected to the base body by other elements. Particularly preferable, however, the section is otherwise detached from the base body, so that its mobility/deformability is not restricted. Due to the fastening section, the section is distanced from the base body and thus also the cooling hose. As a result, when the motor vehicle is in operation, for example, chafing of the cooling hose on the base body is avoided. Conveniently, the fastening section stands essentially vertically on the base body. Thus, if the spring tongues are deformed, especially when the cooling hose is inserted between the two spring tongues, there is at least partial elastic bending/kinking of the spring tongues in the area of the connection to the base body. Thus, even a small acting force leads to a comparatively wide spreading of the spring tongues, so that the insertion of the cooling hose is easier.

Alternatively or particularly preferably, in combination hereto, an insertion section pointing away from the axis can be molded at each section at a second end, which forms the end that is particularly opposite the first end. If both the fastening section and the insertion section are present, they are conveniently located in a common plane with the respective section, which is perpendicular to the axis. Thus, the cross-section of the spring tongue perpendicular to the axis, or at least the unit formed by the section, the fastening section, and the insertion section, is essentially omega-shaped. By means of the insertion sections of the two spring tongues and the corresponding arrangement, a V-shaped or funnel-shaped area is formed, through which the cooling hose is inserted between the two sections. Thus, by inserting the cooling hose onto the insertion sections, a force is exerted, which leads to a spring-elastic spread of the two spring tongues, so that the radiator hose can be mounted between the two spring tongues. When the radiator hose is then inserted there, the funnel shape prevents the cooling hose from detaching independently, wherein manual spreading is possible by applying force to the insertion sections to dismantle the cooling hose.

For example, each spring tongue can have only one corresponding section, to which, for example, the associated insertion section and/or fastening section is molded. However, each spring tongue has two such sections, which are arranged offset from each other along the axis. In particular, the two sections of the same spring tongue are congruent with each other in a projection along the axis. Due to the two sections, a comparatively safe holding of the cooling hose is possible. For example, the two sections of the same spring tongue are no longer mechanically connected to each other, in particular only via the base body. This increases flexibility.

However, particularly preferably, the two insertion sections of the same spring tongue can be connected to each other by means of a holding section of the respective spring tongue running parallel to the axis. In particular, the insertion sections and the holding sections are molded together. Preferably, the holding section is located at the opposite end of the insertion sections. Due to the holding sections, force can be exerted on the two sections of the same spring tongues by operating the respective holding section, so that the two sections are bent/moved at least partially synchronously or at least in coordination with each other. This makes it easier to insert the cooling hose. Also, in the event of subsequent disassembly, only the force applied to the holding section is required, avoiding tearing off or damaging the cooling hose and/or the holder. This simplifies maintenance. In this way, the ends of the spring tongue facing away from the base body are also enlarged, so that when the cooling hose is mounted, there is no punctual force applied to it, which could otherwise lead to perforation. This makes installation easier and reduces rejects.

Preferably, each section and the insertion section as well as the fastening section, if they are present, can be arranged in a common plane perpendicular to the axis. In particular, each spring tongue is essentially U-shaped. Due to the U-shape, the individual components of the respective spring tongue are stabilized in relation to each other, and tearing off the individual sections/fastening sections from the base body is avoided. The spring tongue also rests on the cooling hose at several points, so that it is gripped comparatively stably-due to the essentially not full-surface fit along the axis, the force required for deformation when mounting the cooling hose is reduced.

For example, the two sections of the same spring tongue can each be offset by the same amount along the axis. Alternatively or in combination with this, the two spring tongues are offset from each other along the axis. Thus, construction is simplified. However, it is particularly preferable that between the two sections of one of the spring tongues, at least one of the sections of the other spring tongue is arranged along the axis. Thus, a comparatively compact holder is provided. Particularly preferably, the two sections of one spring tongue are surrounded by the two sections of the other spring tongue, especially in one direction parallel to the axis. In other words, the two sections of one of the spring tongues surround the two sections of the other spring tongue. Thus, on the one hand, a comparatively compact holder is provided. It is also possible, for example, to design the two inner sections comparatively filigree, as they are surrounded by the other sections and thus protected. Due to the filigree design, in turn, it is possible to deform with a reduced force, which makes assembly easier.

For example, only the holder may be present. However, particularly preferably, the fan shroud includes several such holders, which are molded to the base body. Conveniently, the number of holders is equal to 2, 3 or 4. In particular, the number of holders is less than 10 or 8. As a result, the cooling hose can be guided along the fan shroud by means of the holders, so that its arrangement is comparatively precise.

The radiator module can be for a motor vehicle and therefore preferably a component of the motor vehicle when assembled. Thus, the radiator module is suitable, in particular provided and set up, to be mounted on other components of the motor vehicle. The motor vehicle is suitably land-bound and, for example, a passenger car. Alternatively, the motor vehicle is a commercial vehicle, for example a truck or a bus.

When assembled, the radiator module can be used in particular to cool down a fluid, in particular a cooling liquid, which is passed through the radiator module during operation. The cooling liquid is, for example, a coolant or a refrigerant. Thus, the radiator module is a component of a cooling circuit or a refrigerant circuit, for example. For example, the coolant is used to cool a motor vehicle's combustion engine. If the radiator module is part of the refrigerant circuit, the radiator module is used in particular to cool down the energy storage system of the motor vehicle, preferably batteries. Alternatively, the radiator module is used to control the temperature of an interior of the motor vehicle. The refrigerant circuit preferably has an evaporator and/or compressor.

The radiator module can have a fan shroud with a base body and a holder for attaching a cooling hose, wherein the holder is molded to the base body and has two spring tongues for at least partial gripping of the cooling hose. In addition, the radiator module has a radiator hose, which is at least partially gripped by means of the spring tongues. Preferably, a form fit and/or force fit between the radiator hose and the holder is at least partially realized, especially the spring tongues. Consequently, the radiator hose is attached to the base body and thus to the fan shroud by means of the holder.

The radiator module can also include a fan, which conveniently includes a fan wheel. For example, the fan is formed only by means of the fan wheel. However, the fan is particularly preferably designed with an electric motor, so that the fan wheel is driven by an electric motor of the fan. In particular, the fan wheel is an axial fan wheel, so that when the fan wheel is in operation, air is moved along its axis of rotation. The electric motor is, for example, a brushed commutator motor or, most preferably, a brushless direct current motor (BLDC). The fan is attached to the fan shroud. Thus, the fan is stabilized by means of the fan shroud. In particular, the fan wheel is rotatable with respect to the fan shroud. The fan shroud appropriately has an opening within which the fan wheel is preferably located.

Preferably, the radiator module also can include a radiator network, which in particular has several pipes, made in particular of a metal, and which conveniently extend between two so-called water tanks. Appropriately, the radiator network includes several fins that are adjacent to the pipes on the outside and thermally contacted with them. In particular, the fan is arranged in such a way that air is sucked or blown through the radiator network during operation, depending on the direction of rotation of the fan wheel. In this way, it is possible to amplify or create a flow of air through the radiator network, especially in the absence of a headwind, for example in the event of a standstill of the motor vehicle. By means of the fan shroud, the air flowing through the radiator network is directed, and the formation of leakage air when the fan is in operation, which would lead to a reduction in efficiency, is avoided.

Conveniently, the cooling hose can be connected to the radiator network and thus connected to it in terms of fluid technology. In particular, the cooling liquid guided by the cooling hose during operation is introduced into or discharged from the radiator network.

Furthermore, the invention relates to a motor vehicle with such a radiator module/fan shroud.

The advantages and further developments mentioned in connection with the fan shroud also apply mutatis mutandis to the radiator module/the motor vehicle as well as to each other, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows, a motor vehicle comprising a radiator module with a fan shroud,

FIG. 20 shows in a plan view, a section of the fan shroud, having a base body and two holders,

FIGS. 3 and 4 show one of the holders from different perspectives,

FIG. 5 shows the holder in a side view, and

FIG. 6 shows in perspective, the holder gripped by a cooling hose.

### DETAILED DESCRIPTION

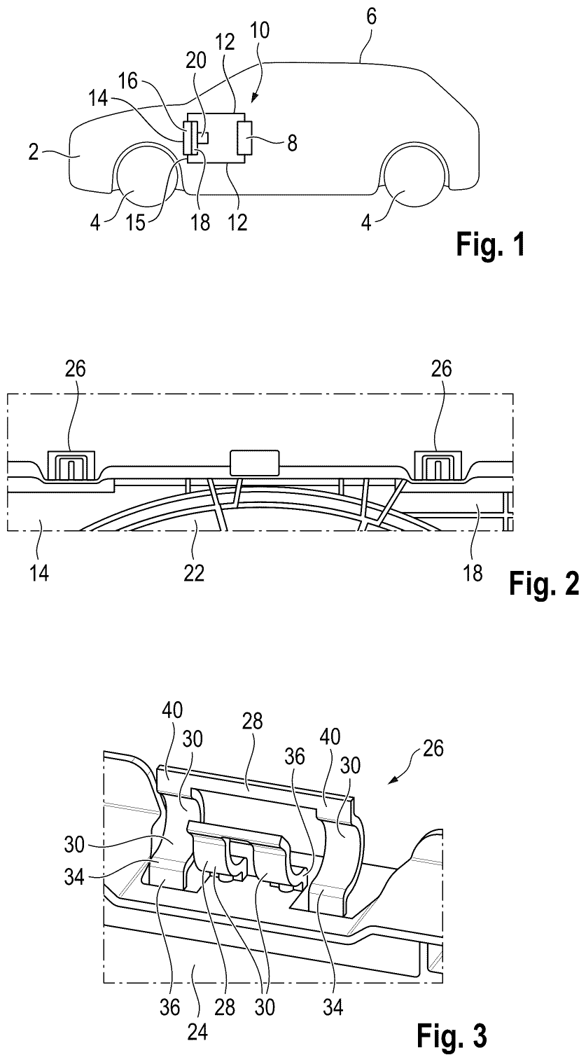

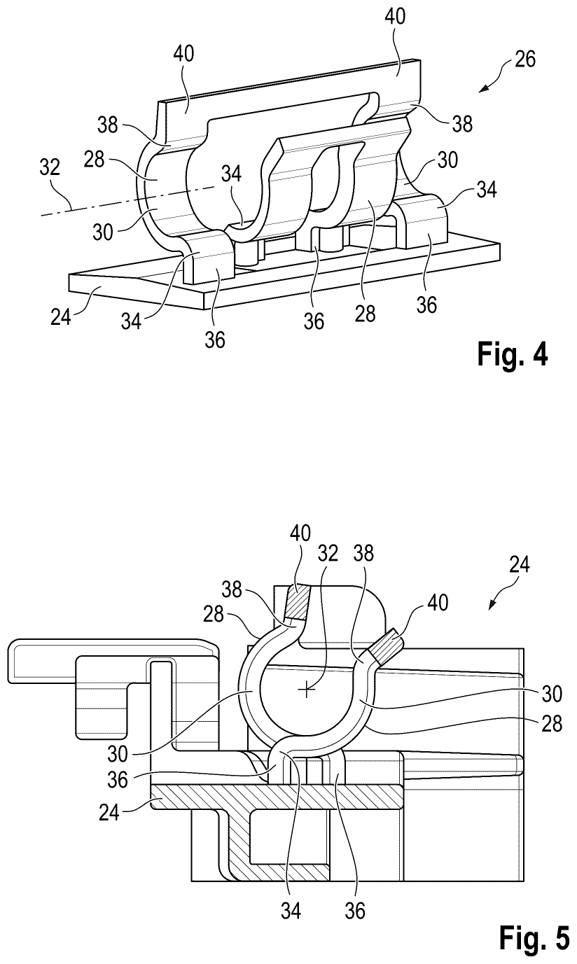

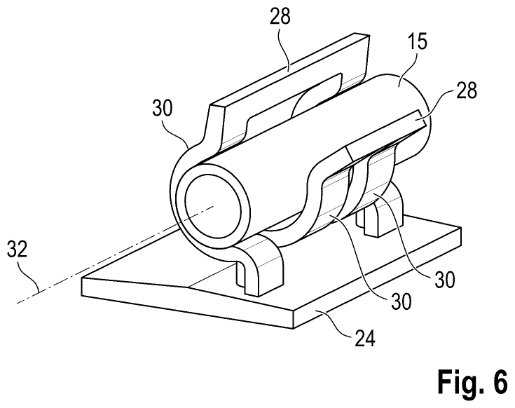

FIG. 1 shows a motor vehicle 2 in the form of a passenger car in a schematically simplified way. The motor vehicle 2 has several wheels 4, which stand on a road surface and are attached to a body 6 of the motor vehicle 2 by means of a chassis. The motor vehicle 2 comprises an element 8 to be cooled, which is designed, for example, as an internal combustion engine, by means of which at least some of the wheels 4 are driven. If the motor vehicle 2 is only electrically powered, the element 8 to be cooled is, for example, an energy storage unit. In another alternative, the element 8 to be cooled is a component of an air conditioning system.

Depending on the design of the element 8 to be cooled, it is a component of a cooling circuit or refrigeration circuit 10, which has several pipes 12 with which the element 8 to be cooled is connected to a radiator module 14. Depending on the design of the cooling circuit/refrigeration circuit 10, a coolant or a refrigerant is transported within the pipes 12 from the element 8 to be cooled to the radiator module 14, by means of which it is cooled. For this purpose, the radiator module 14, namely a cooling hose 15, is connected to the pipes 12 by means of fluid technology. The radiator module 14 has a radiator network 16, which is essentially arranged perpendicular to the vehicle's longitudinal axis, and into which the cooling hose 15 empties. In the direction of the vehicle, behind the radiator network 16, there is a fan shroud 18, by means of which the radiator network is covered, and which is attached to the radiator network 16.

The fan shroud 18 guides the air led through the radiator network 16, increasing its effectiveness. In this case, when the motor vehicle 2 is moving, the headwind is used as air by means of which the radiator network 16 is pressurized. A fan 20 is attached to the fan shroud 18, which is at least partly located in the direction of travel behind the fan shroud 18. The fan 20 comprises an electric motor by means of which a fan wheel is driven, which is at least partially arranged in a round opening 22 (FIG. 2). The axis of rotation of the fan wheel is perpendicular to the expansion of the fan wheel as well as to the expansion of the fan shroud 18 and the radiator network 16. By operating the fan 20, it is possible to generate an air flow so that even when the motor vehicle 2 is at a standstill, air is sucked through the radiator network 16.

FIG. 2 shows a section of the fan shroud 18 in a plan view along the vehicle's longitudinal axis. The fan shroud 18 is single-piece and has an essentially flat base body 24, in which the opening 22 is inserted, and by means of which the radiator network 16 is essentially covered. On the edge of the base body 24, two identical holders 26 are molded, which protrude over the base body 24 on the edge side. In other words, several holders 26 are molded to the base body 24.

The holders 26 are each one-piece and made of the same plastic as the basic body 24. In summary, the individual components of the holders 26 are molded to one another and one-piece. The holders 26 are made of the same material as the base body 24 and are molded to it. The material is a glass fiber reinforced polyamide, namely PA6. For production, the holders 26 and the base body are made by primary forming using a plastic injection molding process.

FIGS. 3 and 4 show one of the holders 26 molded to the base body 24 from different perspectives. In FIG. 5, this is shown in a side view, for which a cross-sectional representation through the fan shroud 18 along the longitudinal axis of the motor vehicle was chosen. The holder 26 has two spring tongues 28, each of which has two arc-shaped sections 30, which are also referred to simply as sections 30. All sections 30 are bent around a common axis 32, to which they have the same distance. In other words, the arc-shaped sections 30 have the same radius.

The sections 30 assigned to the same spring tongue 28 are curved in the same way and offset from each other along the axis 32. The sections 30 are congruent with each other in a projection along the axis 32. The sections 30 assigned to different spring tongues 28 are curved in opposite directions to each other. Thus, the axis 32 is surrounded on the circumferential side by means of the sections 30, wherein the sections 30 are formed/arranged in such a way that the axis 32 is only surrounded by 60%, 70% on the circumferential side.

At a first end 34 of each section 30, a fastening section 36 pointing away from the axis 32 is molded, which essentially stands vertically on the edge of the base body 24. This means that all fastening section 36 are parallel to each other. At an opposite second end 38 of each section 30, an insertion section 40 is molded pointing away from the axis 32.

The insertion sections 40 of different spring tongues 28 point away from each other at ends pointing away from each other at the second end 38, resulting in a funnel shape. The insertion sections 40 of the same spring tongue 28 are connected by means of a holding section 42 running parallel to the axis 32, which holding section is molded to the latter. Thus, each spring tongue 28 is designed in particular in the manner of a cantilever chair, and when force is applied to the holding section 42 perpendicular to the axis 32, the respective spring tongue 28 is deformed in a spring-elastic manner. In this process, a gap between the second ends 38 of different spring tongues 28 is widened or reduced depending on the direction of force. Due to the force applied, the radius of the sections 30 is increased, and the fastening sections 36 are deformed. The sections 30 of one spring tongue 28 are surrounded in one direction parallel to the axis 32 by the sections 30 of the other spring tongues 28. Thus, one of the holding sections 42 is shortened as compared to the other holding section 42.

In the assembled state, which is shown in FIG. 6, the cooling hose 15 is arranged concentrically to the axis 32, to which the sections 30 are form- and force-fitting on the outside. In other words, the cooling hose 15 is gripped by means of the two spring tongues 28 and thus attached to the fan shroud 18. Since the axis 32 is only surrounded by the sections 30 by between 60% and 70%, the cooling hose 15 is also only surrounded by 60% to 70% or slightly less on the circumferential side by means of the sections 30, provided that the spring tongues 28 are slightly elastically bent to achieve the force-fit.

For assembly, the cooling hose 15 is arranged in the area of the two holding sections 42 parallel to the axis 32 and then a force is exerted on it in the direction of the axis 32. As a result, the cooling hose 15 slides along the insertion sections 40 in the direction of the axis 32, wherein, due to the acting force and the inclined position of the insertion sections 40, the spring tongues 28 are spread open, so that the gap between the two spring tongues 28 is widened. If the cooling hose 15 is then inserted between the sections 30, the spring tongues 28 spring back due to the force no longer acting on the insertion sections 40 and to the flexible design, so that the gap essentially returns to its original size. As a result, the cooling hose 15 is securely held 10 between the spring tongues 28, with the arc-shaped sections 30 directly in contact with the cooling hose 15 by means of their inner side, forming the form fit and the force fit.

The invention is not limited to the embodiment described above. Rather, other variants of the invention can also be derived from this by the skilled person without departing from the subject-matter of the invention. In particular, all the individual features described in connection with the embodiment can also be combined with each other in other ways without departing from the subject-matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A fan shroud for a motor vehicle, the fan shroud comprising:
a base body; and
a holder to attach a cooling hose, the holder being molded to the base body and comprises two spring tongues to at least partial grip the cooling hose.

2. The fan shroud according to claim 1, wherein each spring tongue has an arc-shaped section for the attachment to the cooling hose that are curved in opposite directions to each other with respect to a common axis.

3. The fan shroud according to claim 2, wherein the common axis is circumferentially gripped by the two sections by between 60% and 70%.

4. The fan shroud according to claim 2, wherein a fastening section, which is attached to the base body and points away from the axis, is molded to each section at a first end.

5. The fan shroud according to claim 2, wherein an insertion section pointing away from the axis is molded to each section at a second end.

6. The fan shroud according to claim 5, wherein each spring tongue has two offset sections along the axis, to each of which the insertion section is molded, and wherein the insertion sections are connected via a holding section running parallel to the axis.

7. The fan shroud according to claim 6, wherein the two sections of one of the spring tongues surround the two sections of the other spring tongue.

8. The fan shroud according to claim 1, wherein two or more holders are molded to the base body.

9. A radiator module for a motor vehicle, the radiator module comprising:
the fan shroud according to claim 1; an
a fan; and
a cooling hose,
wherein the fan is attached to the fan shroud, and
wherein the cooling hose is at least partially gripped via spring tongues.
